(19) United States
(12) Patent Application Publication
(10) Pub. No.: US 2023/0283887 A1
(43) Pub. Date: Sep. 7, 2023

(54) IMAGING APPARATUS AND IMAGE TRANSMISSION/RECEPTION SYSTEM

(71) Applicant: SONY SEMICONDUCTOR SOLUTIONS CORPORATION, KANAGAWA (JP)

(72) Inventor: NORIO YASUDA, KANAGAWA (JP)

(21) Appl. No.: 18/005,659

(22) PCT Filed: Jul. 19, 2021
(86) PCT No.: PCT/JP2021/026970

§ 371 Date: Jan. 16, 2023

(30) Foreign Application Priority Data
Jul. 29, 2020 (JP) 2020-128663

(51) Int. Cl. H04N 23/60; H04N 7/18; H04N 23/80

(52) U.S. Cl. CPC H04N 23/64; H04N 7/188; H04N 7/183; H04N 23/80

(57) ABSTRACT

An imaging apparatus of the present disclosure includes: an imaging unit that performs photography based on a predetermined photographing condition; a reference image storage unit that stores a plurality of reference images corresponding to the photographing condition; and an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit.

### TECHNICAL FIELD

The present disclosure relates to an imaging apparatus that generates image data, and an image transmission/reception system that transmits and receives image data.

### BACKGROUND ART

Examples of an image transmission/reception system include a monitoring system that receives image data, transmitted from a transmitter including a monitoring camera, by a receiver such as a server (see PTL 1). In the monitoring system, for example, time-lapse photography may sometimes be performed, which involves periodic photography at a predetermined time interval (see PTL 2).

### CITATION LIST

### Patent Literature

PTL 1: Japanese Unexamined Patent Application Publication No. 2003-299088

PTL 2: Japanese Unexamined Patent Application Publication No. 2017-188854

### SUMMARY OF THE INVENTION

In a monitoring system, or the like, it is desirable that a data communication amount and power consumption be low.

It is desirable to provide an imaging apparatus and an image transmission/reception system that make it possible to reduce an image data amount and power consumption.

An imaging apparatus according to an embodiment of the present disclosure includes: an imaging unit that performs photography based on a predetermined photographing condition; a reference image storage unit that stores a plurality of reference images corresponding to the photographing condition; and an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit.

An image transmission/reception system according to an embodiment of the present disclosure includes: a transmitter that generates and transmits image data; and a receiver that receives the image data transmitted from the transmitter. The transmitter includes: an imaging unit that performs photography based on a predetermined photographing condition; a reference image storage unit that stores a plurality of reference images corresponding to the photographing condition; an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit; and a communication unit that transmits, as the image data, data on the difference image generated by the encoding unit.

In the imaging apparatus or the image transmission/reception system according to the embodiment of the present disclosure, in a case where photography by the imaging unit is performed, a reference image corresponding to the photographing condition at the time when photography has been performed is selected from among the plurality of reference images stored in the reference image storage unit, and a difference image between the selected reference image and an image captured by the imaging unit is generated.

### BRIEF DESCRIPTION OF THE DRAWINGS

FIG. 1 is a configuration diagram illustrating an overview of an image transmission/reception system according to a comparative example.

FIG. 2 is a configuration diagram schematically illustrating a configuration example of an image transmission/reception system according to a first embodiment of the present disclosure.

FIG. 3 is a block diagram schematically illustrating a configuration example of a camera in the image transmission/reception system according to the first embodiment.

FIG. 4 is a block diagram schematically illustrating a configuration example of a receiver in the image transmission/reception system according to the first embodiment.

FIG. 5 is an explanatory diagram illustrating an overview of an operation of the image transmission/reception system according to the first embodiment.

FIG. 6 is an explanatory diagram illustrating a specific example of predicted image quality parameters.

FIG. 7 is an explanatory diagram illustrating an overview of the predicted image quality parameters.

FIG. 8 is an explanatory diagram illustrating an example of image quality adjustment processing using the predicted image quality parameters illustrated in FIG. 7.

FIG. 9 is an explanatory diagram illustrating a specific example of a reference image data table.

FIG. 10 is an explanatory diagram illustrating an overview of reference images.

FIG. 11 is an explanatory diagram illustrating an example of processing to encode image data using the reference images illustrated in FIG. 10.

FIG. 12 is a flowchart schematically illustrating an example of overall processing of the image transmission/reception system according to the first embodiment.

FIG. 13 is a flowchart schematically illustrating an example of camera-side image quality adjustment processing in the image transmission/reception system according to the first embodiment.

FIG. 14 is a flowchart schematically illustrating an example of communication processing performed in response to the image quality adjustment processing on a side of the receiver in the image transmission/reception system according to the first embodiment.

FIG. 15 is a flowchart schematically illustrating an example of the camera-side encoding processing in the image transmission/reception system according to the first embodiment.

FIG. 16 is a flowchart schematically illustrating an example of communication processing performed in response to the encoding processing on the side of the receiver in the image transmission/reception system according to the first embodiment.

### MODES FOR CARRYING OUT THE INVENTION

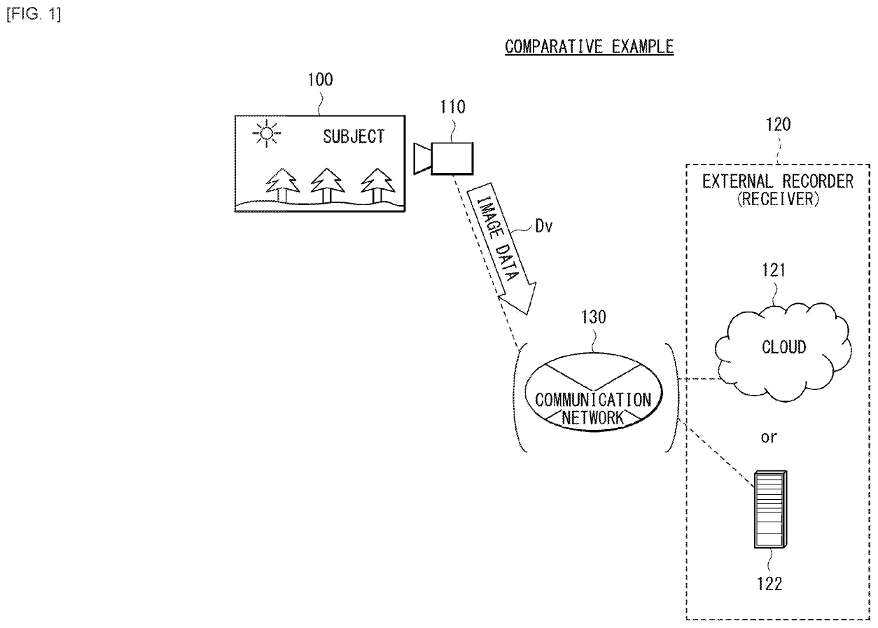

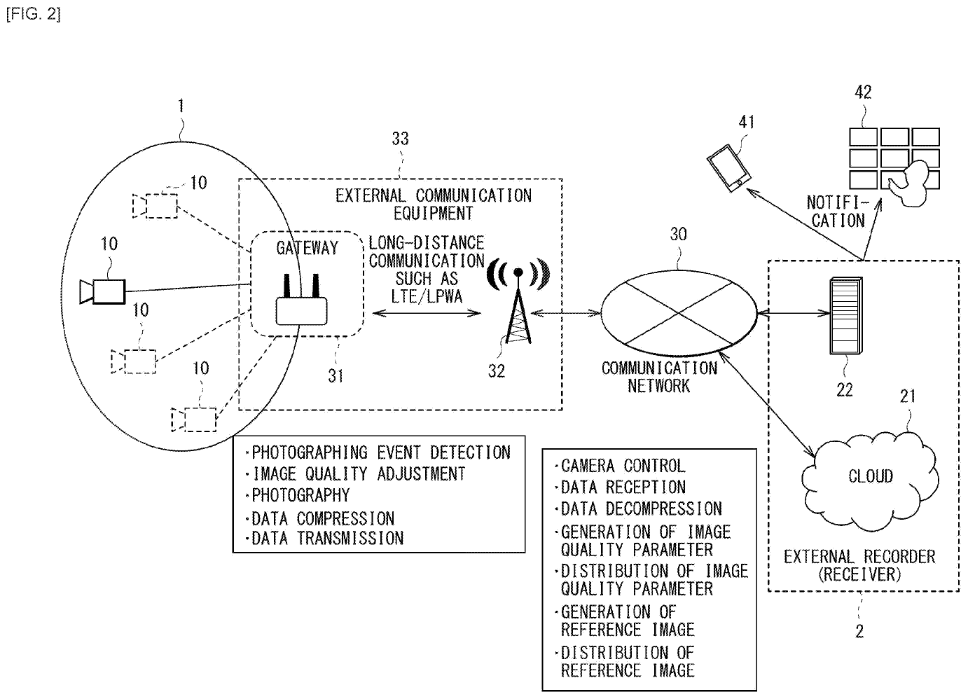

Hereinafter, description is given in detail of embodiments of the present disclosure with reference to the drawings. It is to be noted that the description is given in the following order.
0. Comparative Example (FIG. 1)
1. First Embodiment (FIGS. 2 to 16)
   1.1 Configuration
   1.2 Operation
   1.3 Effects
   1.4 Modification Examples
2. Other Embodiments

### 0. Comparative Example

### Overview and Issue of Image Transmission/Reception System according to Comparative Example

FIG. 1 illustrates an overview of an image transmission/reception system according to a comparative example.

Examples of the image transmission/reception system according to a comparative example include a system in which image data Dv transmitted from a transmitter including a camera 110 is received and recorded in an external recorder 120 as a receiver via a communication network 130 such as the Internet.

The camera 110 is a monitoring camera including, for example, an IoT (Internet of Things) camera, which configures, as the image transmission/reception system, a monitoring system that monitors a subject 100, for example. In the monitoring system, for example, time-lapse photography that involves periodic photography at a predetermined time interval, fixed-point photography that involves photography at a fixed position, and the like are performed.

The external recorder 120 is, for example, a cloud 121 or a server 122. The server 122 is a personal computer (PC) or a recording server.

In the image transmission/reception system according to the comparative example, the camera 110 performs automatic image quality adjustment such as AE (Automatic Exposure), AWB (auto white balance), and AF (auto focus) upon photography. For this reason, the image quality adjustment requires a certain period of time (convergence processing by looping of photography→image quality adjustment→photography), thus making it difficult to reduce the period of time until photography. This causes operation time to be longer, thus increasing power consumption.

In addition, the camera 110 transmits image data generated by photography as still image compressed data by means of a still image codec, for example. In addition, the camera 110 transmits image data as moving image compressed data by means of a moving image codec. As for the moving image compressed data, for example, difference data with respect to a past image is transmitted. Here, in a case of a method using the moving image codec, an existing moving image codec is used, and thus is not optimized for a condition for unique photography such as fixed-point photography. In a case of a method using the still image codec, an amount of communication data is increased, as compared with the method using the moving image codec. In a use environment in which low power consumption is particularly required, such as IoT-related equipment, the amount of communication data directly affects power consumption and communication fees. Therefore, the method using the still image codec is inferior to the method using the moving image codec from the viewpoint of low power and low communication fees required for IoT devices.

### 1. First Embodiment

### 1.1 Configuration

### System Configuration

FIG. 2 schematically illustrates a configuration example of an image transmission/reception system according to a first embodiment of the present disclosure.

The image transmission/reception system according to the first embodiment includes a transmitter 1 that generates and transmits image data, and an external recorder 2 as a receiver that receives the image data transmitted from the transmitter. The image transmission/reception system according to the first embodiment is suitable, for example, for a monitoring system that periodically transmits image data from the transmitter 1 to the external recorder 2. However, the image transmission/reception system according to the first embodiment is also applicable to a system other than the monitoring system.

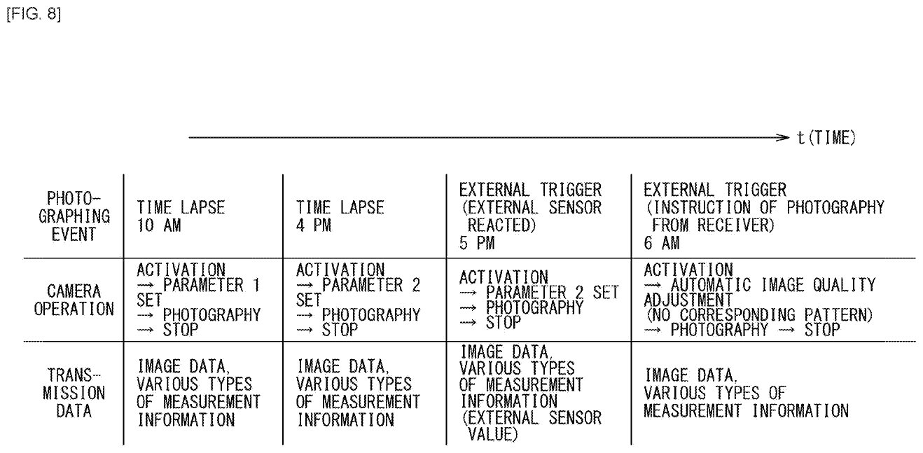

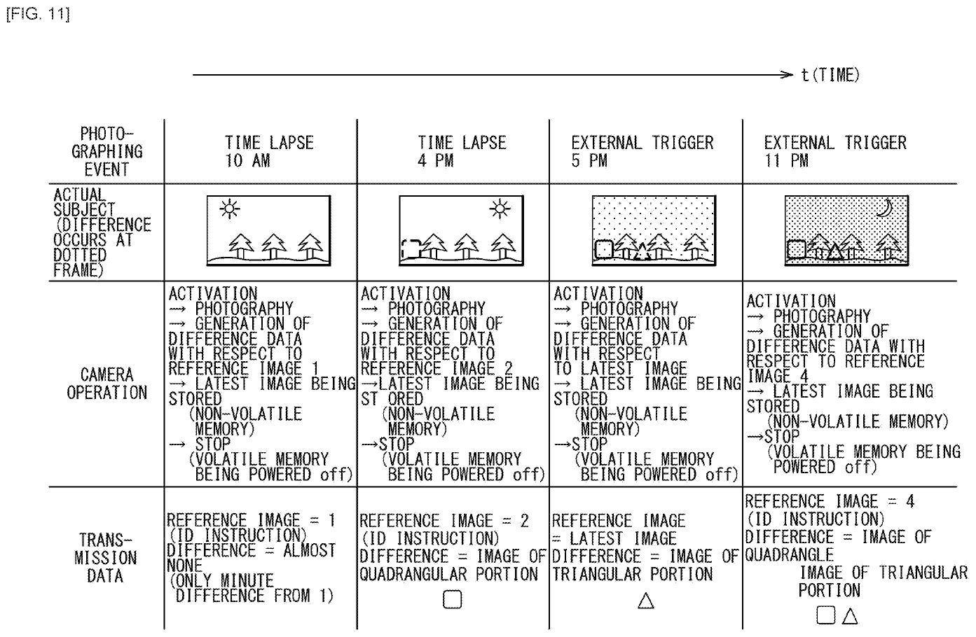

The transmitter 1 includes one or a plurality of cameras 10. The camera 10 is, for example, a monitoring camera including an IoT (Internet of Things) camera. The camera 10 performs photography based on a predetermined photographing condition. For example, the camera 10 performs time-lapse photography in which temporally regular photography, e.g., periodic photography is performed at a predetermined time interval. In addition, the camera 10 performs positionally regular fixed-point photography. The camera 10 is triggered by detection of a photographing event based on a predetermined photographing condition to perform photography, and performs image quality adjustment, data compression (encoding), and the like. Thereafter, the camera 10 transmits the data to the external recorder 2. As illustrated in FIGS. 8 and 11 described later, examples of the photographing event include arrival of a periodic time in a case of performing the time-lapse photography and an external trigger based on a detection result of an external sensor (a human detection sensor, a water level sensor, etc.) that measures various types of information on a monitoring target. In addition, the external trigger may be an instruction of photography from the external recorder 2.

The external recorder 2 is, for example, a cloud 21 or a server 22. The server 22 is a PC or a recording server. The external recorder 2 performs control of the camera 10 (instruction of photography, etc.), data reception from the camera 10, and decompression (decoding) of data from the camera 10. In addition, the external recorder 2, for example, generates and distributes a predicted image quality parameter described later, and generates and distributes a reference image described later. In addition, the external recorder 2 may notify a mobile terminal 41 such as a smartphone, a surveillance monitor 42, and the like of a result, etc. of monitoring by the camera 10.

The transmitter 1 and the external recorder 2 are able to communicate with each other via a wireless or wired network. The transmitter 1 and the external recorder 2 are able to communicate with each other via, for example, an external communication equipment 33 and a communication network 30 such as the Internet. The external communication equipment 33 may be, for example, a gateway 31 or a base station 32. The gateway 31 and the base station 32 may be able to perform long-distance communication using LTE or LPWA (Low Power Wide Area). It is to be noted that the gateway 31 may perform some of operations to be performed by the external recorder 2 described above. For example, the gateway 31 may perform the control of the camera 10, the distribution of the predicted image quality parameter, the distribution of the reference image, and the like.

### Configuration of Transmitter 1 (Camera 10)

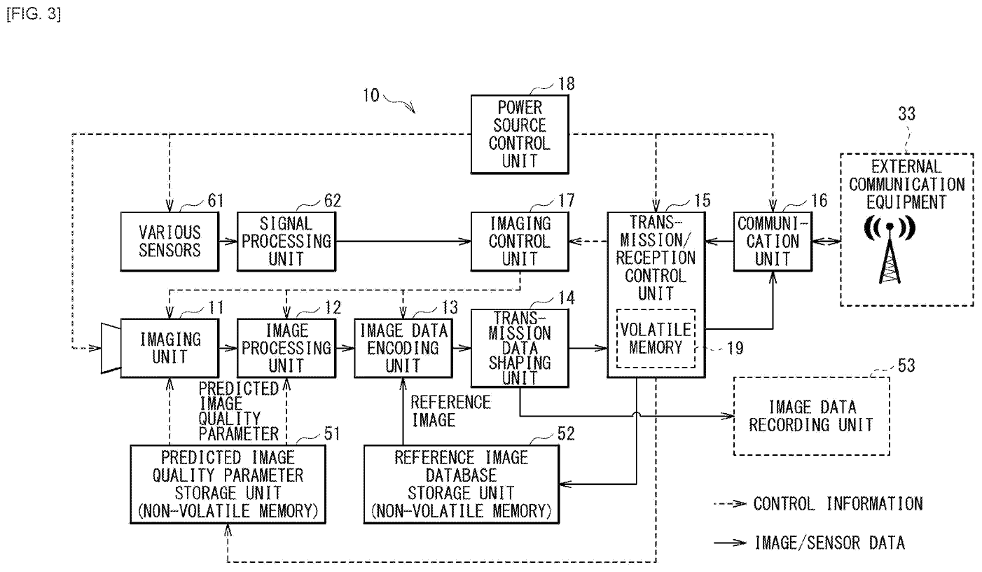

FIG. 3 schematically illustrates a configuration example of the transmitter 1 (camera 10) in the image transmission/reception system according to the first embodiment.

The camera 10 includes an imaging unit 11, an image processing unit 12, an image data encoding unit 13, a transmission data shaping unit 14, a transmission/reception control unit 15, a communication unit 16, an imaging control unit 17, and a power source control unit 18. In addition, the camera 10 includes a predicted image quality parameter storage unit 51 and a reference image database storage unit 52. In addition, the camera 10 includes various sensors 61 and a signal processing unit 62.

The camera 10 corresponds to a specific example of an “imaging apparatus” in the technology of the present disclosure. The imaging unit 11 corresponds to a specific example of an “imaging unit” in the technology of the present disclosure. The image processing unit 12 corresponds to a specific example of an “image processing unit” in the technology of the present disclosure. The image data encoding unit 13 corresponds to a specific example of an “encoding unit” in the technology of the present disclosure. The imaging control unit 17 corresponds to a specific example of an “imaging control unit” in the technology of the present disclosure. The predicted image quality parameter storage unit 51 corresponds to a specific example of an “image quality parameter storage unit” in the technology of the present disclosure. The reference image database storage unit 52 corresponds to a specific example of a “reference image storage unit” in the technology of the present disclosure. The various sensors 61 each correspond to a specific example of a “sensor” in the technology of the present disclosure.

The imaging unit 11 includes a lens, an image sensor, and an illumination device. The imaging unit 11 performs photography based on a predetermined photographing condition under the control of the imaging control unit 17. The photographing condition includes, for example, a condition concerning photographing time in the case of performing the time-lapse photography, for example. In addition, the photographing condition includes a condition based on information measured by the various sensors 61. In addition, the photographing condition includes a condition based on an instruction of photography from the external recorder 2. The imaging unit 11 at least performs temporally regular time-lapse photography on the basis of the photographing condition. In addition, the imaging unit 11 may perform positionally regular fixed-point photography.

The image processing unit 12 performs preprocessing on an image captured by the imaging unit 11. The image processing unit 12 performs, as the preprocessing, for example, development, correction of gradation and color tone, denoising, distortion correction, and size conversion. The image processing unit 12 determines a predicted image quality parameter to be used from the photographing condition. In a case where the imaging unit 11 performs photography, the image processing unit 12 selects, from among a plurality of predicted image quality parameters stored in the predicted image quality parameter storage unit 51, a predicted image quality parameter corresponding to the photographing condition at the time when the photography has been performed. The image processing unit 12 then performs image quality adjustment based on the selected predicted image quality parameter on the image captured by the imaging unit 11. In a case where there is no predicted image quality parameter corresponding to the photographing condition at the time when the photography has been performed, the image processing unit 12 performs automatic image quality adjustment processing without using the predicted image quality parameter.

The image data encoding unit 13 performs encoding processing (compression, encoding) using a still image codec or a moving image codec. In a case where the imaging unit 11 performs photography, the image data encoding unit 13 selects, from among a plurality of reference images stored in the reference image database storage unit 52, a reference image corresponding to the photographing condition at the time when photography has been performed. The image data encoding unit 13 then generates a difference image between the selected reference image and the image captured by the imaging unit 11. The image data encoding unit 13 generates a difference image between the selected reference image and a captured image after having been subjected to the image quality adjustment by the image processing unit 12. In a case where there is no reference image corresponding to the photographing condition at the time when the photography has been performed, the image data encoding unit 13 generates a difference image between a latest image and the image captured by the imaging unit 11 without using a reference image.

The transmission data shaping unit 14 adds various types of additional information acquired from the image sensor of the imaging unit 11 and the various sensors 61 to image data encoded by the image data encoding unit 13, thus shaping the added data as transmission data. The transmission data shaping unit 14 performs data shaping and queuing into a reduced image, a cut-out image, or the like, in cooperation with external equipment.

The transmission/reception control unit 15 has a volatile memory 19. The transmission/reception control unit 15 performs packetizing in accordance with a communication protocol to perform data transmission/reception control. In addition, the transmission/reception control unit 15 notifies the imaging control unit 17 of photography control information on reception data.

The communication unit 16 performs communication processing. Examples of a communication method to be performed by the communication unit 16 may include WiFi or LTE. The communication unit 16 transmits, as image data, data on the difference image generated by the image data encoding unit 13 to the external recorder 2. The communication unit 16 receives, from the external recorder 2, reference images generated on the basis of the image data received by the external recorder 2. The communication unit 16 receives, from the external recorder 2, predicted image quality parameters generated on the basis of the image data received by the external recorder 2. The communication unit 16 transmits, together with the image data, information measured by the various sensors 61 at the time of photography to the external recorder 2.

The imaging control unit 17 gives an imaging instruction to the imaging unit 11 on the basis of the measurement information from the various sensors 61. For example, the imaging control unit 17 changes, for each block, various control parameters in accordance with the information from the transmission/reception control unit 15. The imaging control unit 17 selects, from among the plurality of predicted image quality parameters stored in the predicted image quality parameter storage unit 51, a predicted image quality parameter corresponding to the photographing condition. The imaging control unit 17 then causes the imaging unit 11 to perform photography based on the selected predicted image quality parameter. In a case where there is no predicted image quality parameter corresponding to the photographing condition at the time when the photography has been performed, the imaging control unit 17 causes the imaging unit 11 to perform photography by means of automatic photography control without using a predicted image quality parameter.

The power source control unit 18 monitors ON/OFF control of a power source and a remaining amount of the power source of each block.

The predicted image quality parameter storage unit 51 includes a non-volatile memory. The predicted image quality parameter storage unit 51 stores a plurality of predicted image quality parameters related to image quality adjustment corresponding to the photographing condition. The predicted image quality parameter storage unit 51 stores the predicted image quality parameters received by the communication unit 16 from the external recorder 2.

The reference image database storage unit 52 includes a non-volatile memory. The reference image database storage unit 52 stores a plurality of reference images corresponding to the photographing condition. The reference image database storage unit 52 may store the plurality of reference images and a latest image, which is the newest in terms of time, captured by the imaging unit 11. The reference image database storage unit 52 stores the reference images received by the communication unit 16 from the external recorder 2.

The various sensors 61 are various sensors groups for detecting or acquiring physical amounts other than the image data. The various sensors 61 may be, for example, various external sensors that measure external information at the time of photography by the imaging unit 11. The various sensors 61 may each be, for example, a human detection sensor, a water level sensor, a rain sensor, a door open/close sensor, or the like.

The signal processing unit 62 performs A/D conversion on an output from the various sensors 61, and performs denoising, frequency analysis, and the like as preprocessing.

In addition, the camera 10 may further include an image data recording unit 53. The image data recording unit 53 may record data, or the like on difference images similar to data to be transmitted to the external recorder 2.

### Configuration of Receiver (External Recorder 2)

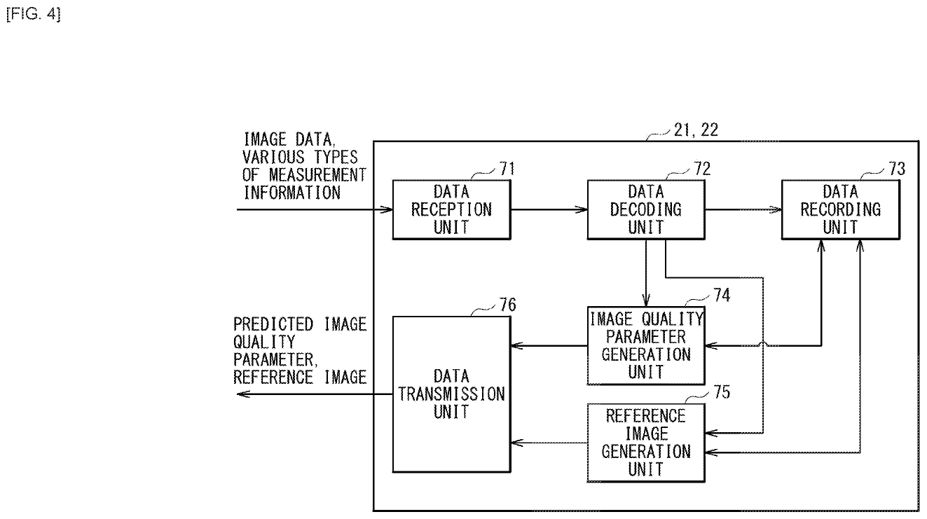

FIG. 4 schematically illustrates a configuration example of a receiver (external recorder 2) in the image transmission/reception system according to the first embodiment.

The external recorder 2 (cloud 21 or server 22) includes a data reception unit 71, a data decoding unit 72, a data recording unit 73, an image quality parameter generation unit 74, a reference image generation unit 75, and a data transmission unit 76.

The image quality parameter generation unit 74 corresponds to a specific example of an “image quality parameter generation unit” in the technology of the present disclosure. The reference image generation unit 75 corresponds to a specific example of a “reference image generation unit” in the technology of the present disclosure. The data transmission unit 76 corresponds to a specific example of a “transmission unit” in the technology of the present disclosure.

The data reception unit 71 receives image data and various types of measurement information from the transmitter 1 (camera 10).

The data decoding unit 72 performs decoding (decompression) processing on data received by the data reception unit 71.

The data recording unit 73 records image data decoded by the data decoding unit 72 and the various types of measurement information.

The image quality parameter generation unit 74 generates a predicted image quality parameter on the basis of the image data and the various types of measurement information from the transmitter 1.

The reference image generation unit 75 generates a reference image on the basis of the image data and the various types of measurement information from the transmitter 1.

The data transmission unit 76 transmits the reference image generated by the reference image generation unit 75 to the transmitter 1. In addition, the data transmission unit 76 transmits the predicted image quality parameter generated by the image quality parameter generation unit 74 to the transmitter 1. In addition, the data transmission unit 76 transmits, to the transmitter 1, control information such as an instruction of photography for the camera 10.

### 1.2 Operation

### Overview of Operation

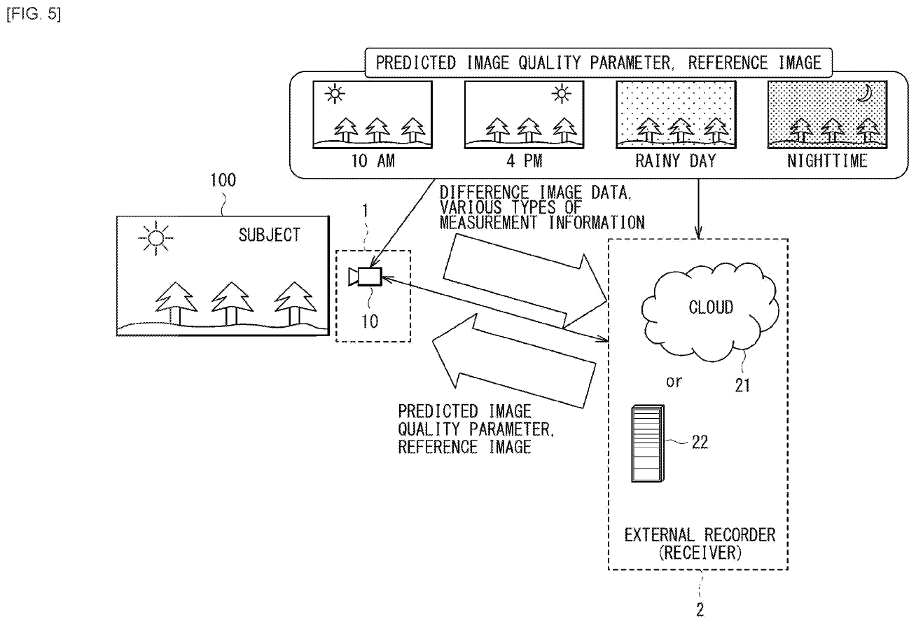

FIG. 5 illustrates an overview of an operation of the image transmission/reception system according to the first embodiment.

The transmitter 1 (camera 10) and the external recorder 2 communicate with each other via, for example, the external communication equipment 33 and the communication network 30 such as the Internet. The camera 10 transmits, as image data, data on a difference image between a reference image or a latest image and a captured image to the external recorder 2. In addition, the camera 10 transmits, to the external recorder 2, information measured by the various sensors 61 at the time of photography together with the image data. The external recorder 2 transmits a predicted image quality parameter generated on the basis of the received image data and the measurement information to the camera 10. In addition, the external recorder 2 transmits, to the camera 10, a reference image generated on the basis of the received image data and the measurement information. In addition, the external recorder 2 transmits, to the camera 10, control information such as an instruction of photography for the camera 10.

The camera 10 performs photography with a certain rule-based nature in a photographing schedule or a subject, e.g., fixed-point photography or time-lapse photography. The camera 10 performs image quality adjustment on a captured image using a predicted image quality parameter prepared in advance. This enables the camera 10 to perform instantaneous photography by skipping convergence time as in existing automatic image quality adjustment. In addition, the camera 10 uses a reference image prepared in advance to perform compression or encoding by inter-frame prediction as in a moving image codec, for example. Thus, a higher compression ratio is expectable than encoding using only a single piece of overall captured image.

In addition, the camera 10 powers the volatile memory 19, etc. ON and OFF in order to reduce power consumption as needed, instead of performing successive frame processing in which photography is performed with each block being powered ON. The camera 10 stores, in the non-volatile memory, the predicted image quality parameter, the reference image, and the latest image, and refers thereto at the next occasion of photography. This enables the camera 10 to achieve low power consumption.

### Image Quality Adjustment Processing

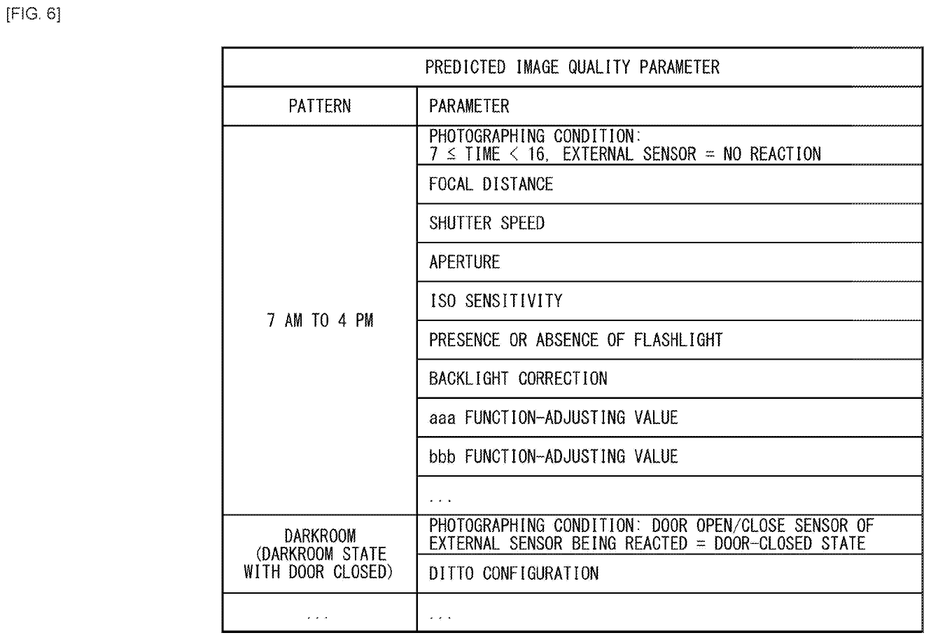

FIG. 6 illustrates a specific example of predicted image quality parameters.

The predicted image quality parameter is a parameter to be used for the image quality adjustment in the camera 10, and has a parameter set for each pattern corresponding to time and environment.

As illustrated in FIG. 6, examples of the predicted image quality parameter include patterns such as 7 AM to 4 PM, and a darkroom (darkroom state with a door closed).

In a case of the pattern of 7 AM to 4 PM, for example, there are the following parameters.
Photographing condition: 7≤time<16, external sensor=no reaction
Focal distance
Shutter speed
Aperture
ISO sensitivity
Presence or absence of flashlight
Backlight correction
aaa function-adjusting value
bbb function-adjusting value

In the case of the pattern of the darkroom, for example, there are the following parameters.
Photographing condition: door open/close sensor of external sensor being reacted=door-closed state

As for other elements, there may be values related to parameters similar to those of the case of 7 AM to 4 PM.

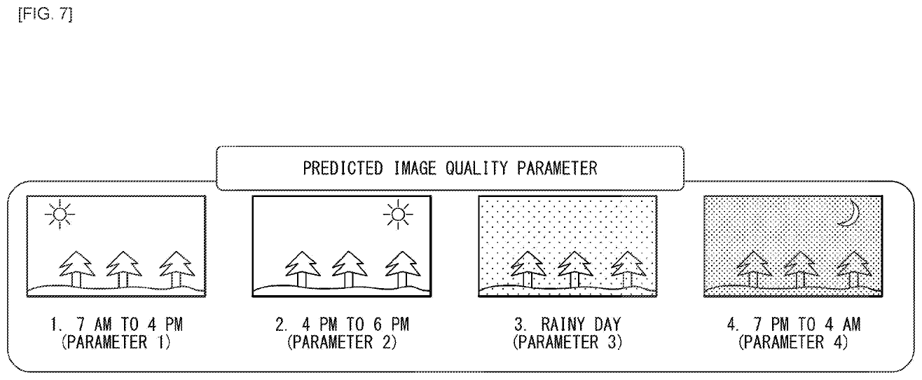

FIG. 7 illustrates an overview of the predicted image quality parameters. FIG. 8 illustrates an example of image quality adjustment processing using the predicted image quality parameters illustrated in FIG. 7.

Here, as illustrated in FIG. 7, it is assumed that the following four parameters are prepared as the predicted image quality parameters. It is assumed that predicted image quality parameters have already been shared between the transmitter 1 (camera 10) and the receiver (external recorder 2).
Parameter 1: pattern of 7 AM to 4 PM
Parameter 2: pattern of 4 PM to 6 PM
Parameter 3: pattern of rainy day
Parameter 4: pattern of 7 PM to 4 AM (nighttime)

In addition, it is assumed that, as photographing events of the photographing condition of the camera 10, there are scheduled time of time-lapse photography (10 AM and 4 PM) and an external trigger. It is assumed that the external trigger includes an instruction of photography from the receiver and a reaction of the external sensor. In the example of FIG. 8, it is assumed that there is a reaction of the external sensor at 5 PM and there is an instruction of photography from the receiver at 6 AM.

In the example of FIG. 8, the time-lapse photography is performed at 10 AM. In this case, as for the operation of the camera 10, an operation is performed in the order of activation→parameter 1 being set as a predicted image quality parameter→photography→stop. The camera 10 transmits, as transmission data, image data and various types of information measured by the external sensor.

In the example of FIG. 8, the time-lapse photography is performed at 4 PM. In this case, as for the operation of the camera 10, an operation is performed in the order of activation→parameter 2 being set as a predicted image quality parameter→photography→stop. The camera 10 transmits, as transmission data, image data and various types of information measured by the external sensor.

In the example of FIG. 8, photography based on the reaction of the external sensor is performed at 5 PM. In this case, as for the operation of the camera 10, an operation is performed in the order of activation→parameter 2 being set as a predicted image quality parameter→photography→stop. The camera 10 transmits, as transmission data, image data and various types of information measured by the external sensor. The various types of information measured by the external sensor includes sensor values by the external sensor having triggered the photography. It is to be noted that, in a case where the image quality adjustment using the parameter 2 is inappropriate as the photography at the time of the reaction of the external sensor, automatic adjustment, new pattern creation, or the like may be selected from the next time.

In the example of FIG. 8, photography based on an instruction of photography from the receiver is performed at 6 AM. In this case, as for the operation of the camera 10, an operation is performed in the order of activation→automatic image quality adjustment→photography→stop. In this case, there is no predicted image quality parameter corresponding at 6 AM, and thus the camera 10 performs automatic image quality adjustment. This enables the automatic image quality adjustment similar to that in the existing technique to be performed, for example, in a photographing condition where a large change in a subject is predicted in a time zone such as sunset.

### Encoding Processing

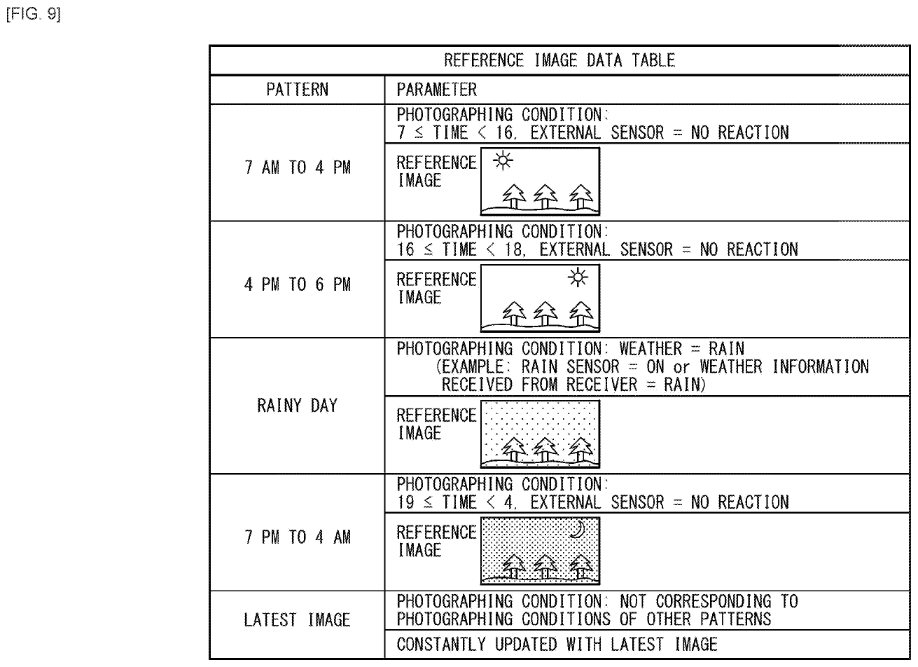

FIG. 9 illustrates a specific example of a reference image data table.

The reference image data table includes data which is to be used for generation of difference data with respect to a photographed image, and such data includes photographing conditions and image data for each pattern corresponding to time and environment.

As illustrated in FIG. 9, the reference image data table includes, for example, patterns such as 7 AM to 4 PM, 4 PM to 6 PM, rainy day, 7 PM to 4 AM, and a latest image.

In the case of the pattern of 7 AM to 4 PM, for example, there are the following photographing condition and reference image.
Photographing condition: 7≤time<16, external sensor=no reaction

In the case of the pattern of 4 PM to 6 PM, for example, there are the following photographing condition and reference image.
Photographing condition: 16≤time<18, external sensor=no reaction

In the case of the pattern of a rainy day, for example, there are the following photographing condition and reference image.
Photographing condition: weather=rain (e.g., rain sensor=ON, or weather information received from receiver=rain)

In the case of the pattern of 7 PM to 4 AM, for example, there are the following photographing condition and reference image.
Photographing condition: 19≤time<4, external sensor=no reaction

In the case of the pattern of a latest image, for example, there are the following photographing condition and latest image:
Photographing condition: not corresponding to photographing conditions of other patterns
Image: constantly updated with latest image

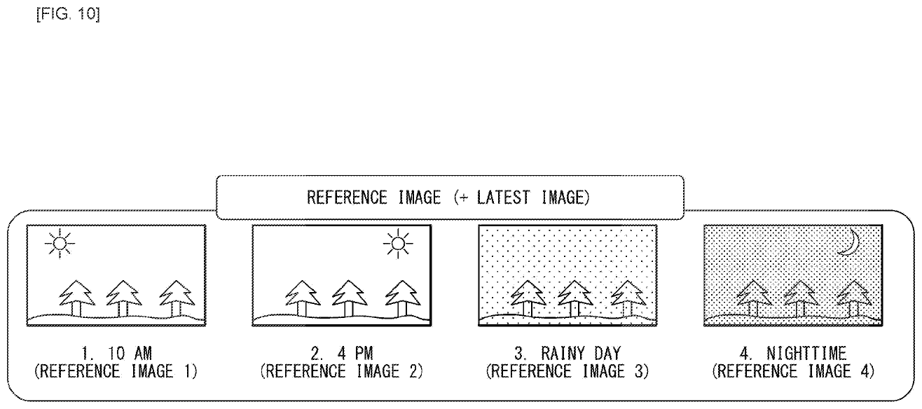

FIG. 10 illustrates an overview of the reference images. FIG. 11 illustrates an example of processing to encode image data using the reference images illustrated in FIG. 10.

Here, as illustrated in FIG. 10, it is assumed that there are prepared four patterns of reference images 1 to 4 and a latest image similar to those of the reference image data table illustrated in FIG. 9. It is assumed that the reference images 1 to 4 and the latest image have already been shared by the transmitter 1 (camera 10) and the receiver (external recorder 2).

In addition, it is assumed that, as the photographing events of the photographing condition of the camera 10, there are scheduled time of time-lapse photography (10 AM and 4 PM) and an external trigger. The external trigger may be an instruction of photography from the receiver or a reaction of the external sensor. In the example of FIG. 11, it is assumed that there are external triggers at 5 PM and 11 PM.

In the example of FIG. 11, the time-lapse photography is performed at 10 AM. In this case, as for the operation of the camera 10, an operation is performed in the order of activation→photography→generation of difference data with respect to reference image 1→storage of latest image in non-volatile memory→stop (volatile memory 19 being powered OFF). The camera 10 transmits, as transmission data, ID=1 of reference image 1 and data on a difference image between the reference image 1 and a photographed image. It is to be noted that, in this example, there is almost no data on a difference image, and only minute difference data with respect to the reference image 1 is transmitted as image data.

In the example of FIG. 11, the time-lapse photography is performed at 4 PM. In this case, as for the operation of the camera 10, an operation is performed in the order of activation→photography→generation of difference data with respect to reference image 2→storage of latest image in non-volatile memory→stop (volatile memory 19 being powered OFF). The camera 10 transmits, as transmission data, ID=2 of the reference image 1 and data on a difference image between the reference image 2 and a photographed image. It is to be noted that, in the example of FIG. 11, a difference from the reference image 2 occurs at a portion (square portion) of a dotted frame of an actual subject. In this example, image data on the square portion is transmitted as data on the difference image.

In the example of FIG. 11, photography based on an external trigger is performed at 5 PM. In this case, as for the operation of the camera 10, an operation is performed in the order of activation→photography→generation of difference data with respect to a latest image→storage of new latest image in non-volatile memory→stop (volatile memory 19 being powered OFF). The camera 10 transmits, as transmission data, data indicating reference image=latest image and data on a difference image between the latest image and a photographed image. It is to be noted that, in the example of FIG. 11, the latest image at 5 PM is an image photographed at 4 PM. In the example of FIG. 11, a difference from the latest image occurs at a portion (triangular portion) of the dotted frame of the actual subject. In this example, image data on the triangular portion is transmitted as data on the difference image.

In the example of FIG. 11, photography based on an external trigger is performed at 11 PM. In this case, as for the operation of the camera 10, an operation is performed in the order of activation→photography→generation of difference data with respect to reference image 4→storage of latest image in non-volatile memory→stop (volatile memory 19 being powered OFF). The camera 10 transmits, as transmission data, ID=4 of the reference image 1 and data on a difference image between the reference image 4 and a photographed image. It is to be noted that, in the example of FIG. 11, a difference from the reference image 4 occurs at each of the square portion and the triangular portion. In this example, image data on each of the square portion and the triangular portion is transmitted as data on the difference image.

### Processing Flow

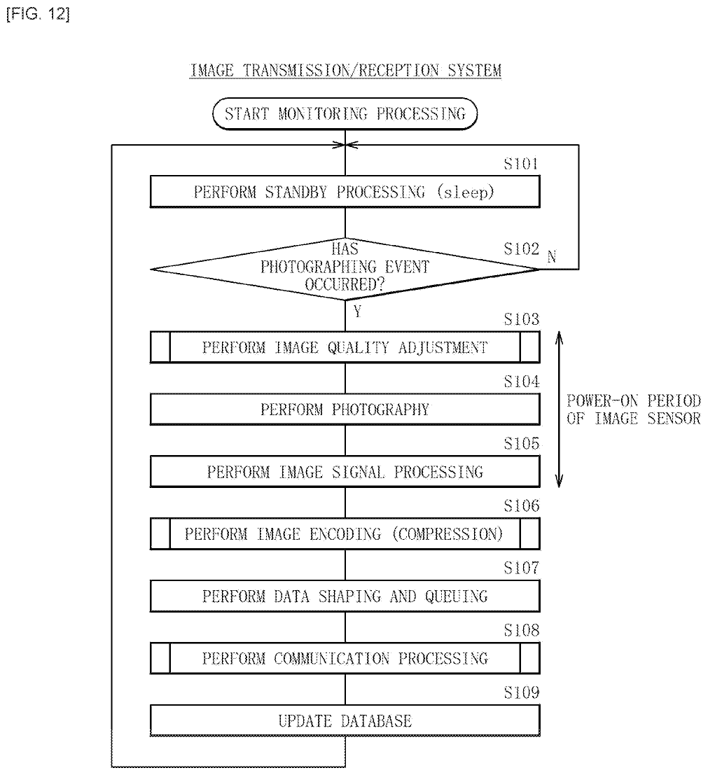

FIG. 12 schematically illustrates an example of a flow of overall processing (monitoring processing) of the image transmission/reception system according to the first embodiment.

As an initial state, the transmitter 1 (camera 10) performs standby processing (sleep) (step S101). Next, the camera 10 determines whether or not a photographing event has occurred (step S102). As described above, examples of the photographing event include arrival of a periodic time in a case of performing time-lapse photography, an external trigger based on a detection result of an external sensor, and an external trigger by an instruction of photography from the external recorder 2. In a case where determination is made that no photographing event has occurred (step S102: N), the camera 10 returns to processing of step S101.

In a case where determination is made that a photographing event has occurred (step S102: Y), the camera 10 then performs image quality adjustment processing (step S103). Next, the camera 10 performs photography (step S104). Next, the camera 10 performs image signal processing (step S105). For example, the camera 10 performs image signal processing such as demosaicking, denoising, gradation correction, and distortion correction on image data (Raw data) acquired by photography. A period during pieces of processing of steps S103 to S105 is a period during which the image sensor in the imaging unit 11 is powered ON. In processing other than those, the image sensor may be powered OFF.

Next, the camera 10 performs image encoding (compression) processing (step S106). Next, the camera 10 performs data shaping and queuing (step S107). For example, the camera 10 adds meta information such as a reference image index, a photographing event type, and time to the image data, shapes the added data as data suitable for a transmission method, and queues the shaped data in a transmission buffer.

Next, the camera 10 and the external recorder 2 (receiver) perform communication processing (step S108). For example, the camera 10 uses an environment-dependent communication means such as WiFi, Bluetooth, ZigBee, or the like for a short distance, and LTE for a long distance.

Next, the camera 10 and the external recorder 2 (receiver) update a database of predicted image quality parameters, reference images, and the like (step S109). Thereafter, the camera 10 returns to the processing of step S101.

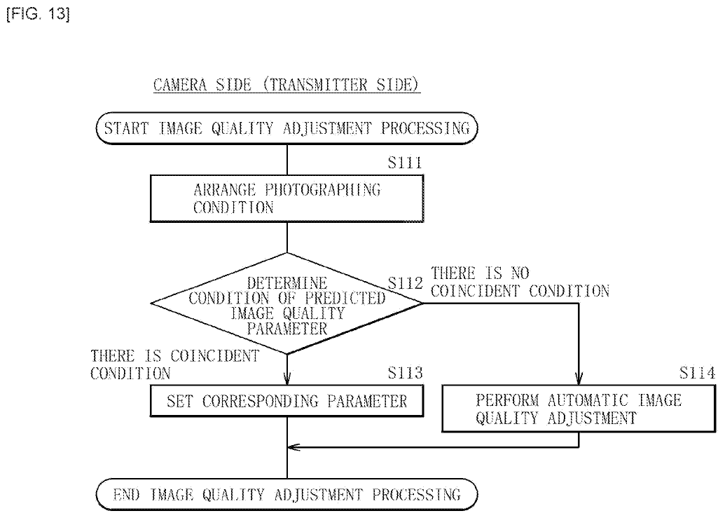

FIG. 13 schematically illustrates an example of a flow of image quality adjustment processing (processing of step S103 in FIG. 12) on a side of the transmitter 1 (camera 10) in the image transmission/reception system according to the first embodiment.

First, the camera 10 arranges the photographing condition (such as time at which the photographing event has occurred) (step S111). Next, the camera 10 determines the photographing condition of the predicted image quality parameter (step S112). In a case where determination is made that there is no photographing condition, in the predicted image quality parameters, coincident with the photographing condition at the time when the photographing event has occurred (step S112: N), the camera 10 performs automatic image quality adjustment (step S114), and ends the image quality adjustment processing.

In a case where determination is made that there is a photographing condition, in the predicted image quality parameters, coincident with the photographing condition at the time when the photographing event has occurred (step S112: Y), the camera 10 then sets the predicted image quality parameter corresponding to the coincident photographing condition as a predicted image quality parameter to be used for the image quality adjustment processing (step S113), and ends the image quality adjustment processing.

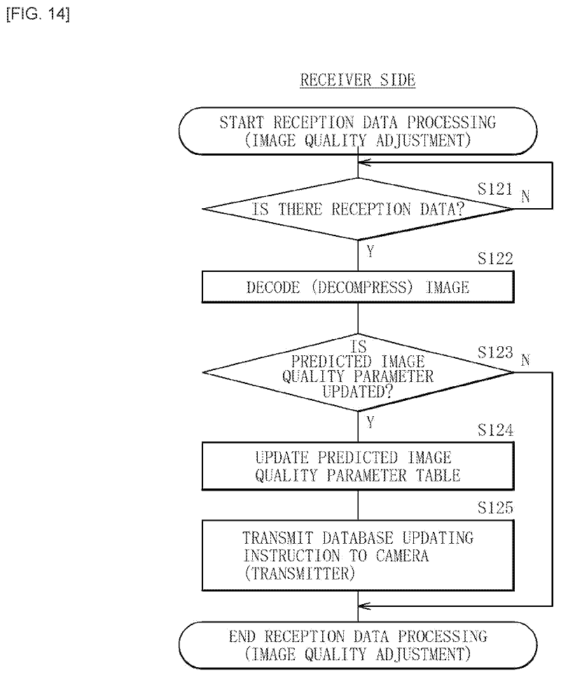

FIG. 14 schematically illustrates an example of a flow of the communication processing (processing of step S108 in FIG. 12, reception data processing) to be performed in a manner corresponding to the image quality adjustment processing, on a side of the receiver (external recorder 2) in the image transmission/reception system according to the first embodiment.

First, the external recorder 2 determines whether or not there is reception data (step S121). In a case where determination is made that there is no reception data (step S121: N), the external recorder 2 repeats the processing of step S121.

In a case where determination is made that there is reception data (step S121: Y), the external recorder 2 then performs image decoding (decompression) processing (step S122). Next, the external recorder 2 determines whether or not the predicted image quality parameter is updated (step S123). In a case where determination is made that the predicted image quality parameter is not updated (S123: N), the external recorder 2 ends the reception data processing.

In a case where determination is made that the predicted image quality parameter is updated (step S123: Y), the external recorder 2 then updates the image quality parameter table (step S124). The external recorder 2 updates a predicted value of the predicted image quality parameter in accordance with, for example, time or environmental information. In addition, the external recorder 2 may perform AI (artificial intelligence) learning from past images, for example, to generate an optimum parameter table. A mode is also conceivable in which the processing to update the predicted image quality parameter is autonomously completed inside the transmitter 1.

Next, the external recorder 2 transmits a database updating instruction to the transmitter 1 (step S125), and ends the reception data processing.

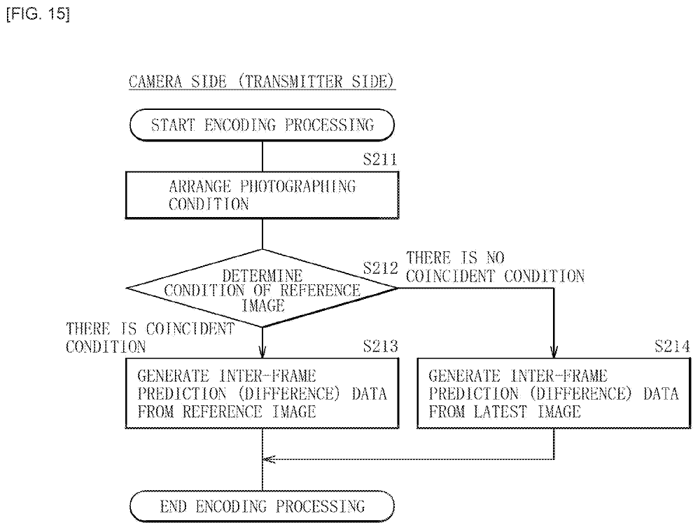

FIG. 15 schematically illustrates an example of a flow of the encoding processing (processing of step S106 in FIG. 12) on the side of the transmitter 1 (camera 10) in the image transmission/reception system according to the first embodiment.

First, the camera 10 arranges the photographing condition (such as time at which the photographing event has occurred) (step S211). Next, the camera 10 determines the photographing condition of the reference image (step S212). In a case where determination is made that there is no photographing condition, in the reference image database, coincident with the photographing condition at the time when the photographing event has occurred (step S212: N), the camera 10 generates inter-frame prediction (difference) data from a latest image (step S214), and ends the encoding processing.

In a case where determination is made that there is a photographing condition, in the reference image database, coincident with the photographing condition at the time when the photographing event has occurred (step S212: Y), the camera 10 then generates inter-frame prediction (difference) data from a reference image corresponding to the coincident photographing condition (step S213), and ends the encoding processing.

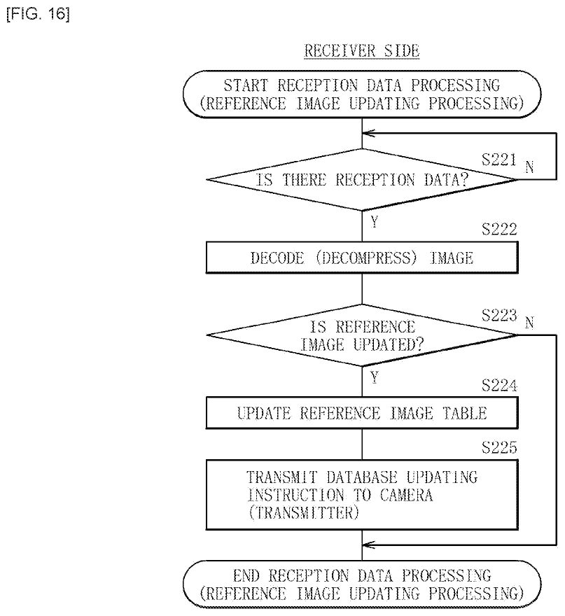

FIG. 16 schematically illustrates an example of a flow of the communication processing (processing of step S108 in FIG. 12, reception data processing (reference image updating processing) to be performed in a manner corresponding to the encoding processing on the side of the receiver (external recorder 2) in the image transmission/reception system according to the first embodiment.

First, the external recorder 2 determines whether or not there is reception data (step S221). In a case where determination is made that there is no reception data (step S221: N), the external recorder 2 repeats the processing of step S221.

In a case where determination is made that there is reception data (step S221: Y), the external recorder 2 then performs image decoding (decompression) processing (step S222). Next, the external recorder 2 determines whether or not the reference image is updated (step S223). In a case where determination is made that the reference image is not updated (S223: N), the external recorder 2 ends the reception data processing.

In a case where determination is made that the reference image is updated (step S223: Y), the external recorder 2 then updates the reference image table (step S224). The external recorder 2 updates the reference image in accordance with, for example, time or environmental information. In addition, the external recorder 2 may perform AI learning from past images, for example, to generate an optimum reference image table. A mode is also conceivable in which the processing to update the reference image is autonomously completed inside the transmitter 1.

Next, the external recorder 2 transmits a database updating instruction to the transmitter 1 (step S225), and ends the reception data processing.

### 1.3 Effects

As described above, according to the image transmission/reception system of the first embodiment, a reference image corresponding to the photographing condition at the time when the photography has been performed is selected from among the plurality of reference images prepared in advance, and a difference image between the selected reference image and the image captured by the imaging unit 11 is generated, thus making it possible to reduce an image data amount and power consumption.

According to the image transmission/reception system of the first embodiment, a reduction in image quality adjustment time and encoding (compression) of image data are performed, which are optimized for a regular subject and photographing environment in the time-lapse photography, or the like. This makes it possible to achieve a reduction in power consumption and a reduction in a data communication amount (communication band) suitable for an IoT device.

According to the image transmission/reception system of the first embodiment, a predicted image quality adjustment value is used without performing automatic image quality adjustment such as AE, AWB, and AF to thereby omit time necessary for the existing automatic image quality adjustment (convergence operation in a time axis of an adjustment value), thus making it possible to reduce time required for photography. This makes it possible to achieve a reduction in operation time and a reduction in power consumption.

According to the image transmission/reception system of the first embodiment, predicted image quality parameters and reference images are switched in accordance with time or photography environment, thus making it possible to obtain appropriate image quality in different subject environments. In addition, it is possible to achieve higher compression than that in a mere time-series compression technique. For example, it is possible to obtain an appropriate image quality to be predicted by time, seasons, and past information on photography (e.g., dark, bright, sunset, light turned off, etc.). In addition, it is possible to perform processing to utilize, as an estimation parameter from the environmental information, a parameter for a darkroom in the case of a door being closed=darkroom, for example. In addition, it is possible to perform photography based on a parameter manually designated by the side of the receiver, for example.

In addition, according to the image transmission/reception system of the first embodiment, it is possible to transmit an optimum parameter table to the side of the transmitter 1 by performing learning on a predicted image quality parameter and a reference image on the side of the receiver. This makes it possible to improve the image quality without putting a load on the side of the transmitter 1.

In addition, according to the image transmission/reception system of the first embodiment, it is possible to operate the system in various environments by using the same automatic image quality adjustment as that in the existing technique, in a photographing condition in which a subject changes greatly (with no regularity).

In addition, according to the image transmission/reception system of the first embodiment, a plurality of reference images are shared by both of the side of the transmitter 1 and the side of the receiver to communicate difference data with respect to a reference image, thus making it possible to reduce the data amount.

In addition, according to the image transmission/reception system of the first embodiment, a reference image is not placed in the volatile memory 19 on the side of the transmitter 1, and the side of the transmitter 1 is powered OFF in a time zone with no need of photography, thereby making it possible to reduce power consumption.

In addition, according to the image transmission/reception system of the first embodiment, it is possible to apply data compression that does not depend on a specific compression technique (e.g., H. 264, etc.). As for the compression technique as the inter-frame prediction from a reference image, any compression technique is applicable. This allows the latest compression technique to be applicable.

In addition, according to the image transmission/reception system of the first embodiment, there is a mechanism to dynamically update a reference image, thus making it possible to obtain an effect of reducing the data amount with respect to environmental changes.

It is to be noted that the effects described herein are merely illustrative and not limiting, and there may be other effects as well. The same applies to effects of the following other embodiments.

### 1.4 Modification Examples

### Modification Example 1

The predicted image quality parameter and the reference image may be reconstructed using AI learning from image data and various types of measurement information stored on the side of the receiver. A new parameter allows updating of a database of the predicted image quality parameters and the reference images in the camera 10, thus making it possible to constantly achieve optimum image quality adjustment. In addition, in a case where there is a plurality of cameras 10, a database may be distributed to a camera 10 newly provided at a similar installation location from a database of another camera 10. In this case, the camera 10 may be an already-existing camera. This makes it possible to achieve an improvement in parameters of the database after the installation of the camera 10. The construction of the database may not be completed before the installation of the camera 10. In addition, it is possible to allow the database to automatically follow changes in a subject or an environment. The use of the database of the other camera 10 makes it possible to reduce time required for generation of a database of a new camera 10.

### Modification Example 2

A system configuration may be adopted in which at least a portion of the functions of the camera 10 and the functions of the receiver is provided in neighboring external communication equipment 33 (such as the gateway 31). This makes it possible to reduce an amount of communication in LAN (Local Area Network), or the like, for example. For example, such a feature is effective in a narrow band network such as LPWA (Low Power Wide Area) and the LAN. In addition, it is possible to reduce a communication amount of communication in WAN (Wide Area Network), e.g., communication from the gateway 31 to the external Internet, or the like. This makes it possible to reduce communication fees. In addition, concentrating at least a portion of the functions of the camera 10 and the functions of the receiver on the gateway 31, or the like makes it possible to allow the camera 10 to have a simple configuration.

### Modification Example 3

When selecting a reference image corresponding to a photographing condition from a plurality of reference images in the camera 10, the most compression-efficient reference image may be selected by reviewing all of the plurality of reference images. In the camera 10, for example, reference images of the same time zone (e.g., 4 PM) for a plurality of days may be held. In addition, in the camera 10, the most compression-efficient reference image may be selected from the reference images for the plurality of days. In addition, in the camera 10, a reference image in a time zone different from the time zone, during which photography has actually been performed, may be referred to. This makes it possible to further reduce the amount of communication data between the camera 10 and the receiver. For example, it is possible to perform communication suitable for an environment in which the reduction in data amount is most prioritized, e.g., an environment in which pay-per-use billing for the LPWA is performed.

In addition, when selecting a reference image corresponding to a photographing condition from a plurality of reference images in the camera 10, the reference images may be narrowed down in terms of feature amounts of images as well as a plurality of photographing conditions (temperature and weather, etc.). This makes it possible to further reduce processing time.

### Modification Example 4

In the image transmission/reception system, error management may be performed. For example, in a case where the receiver determines that there is abnormality in an image with respect to image quality adjustment, (e.g., in a case where an overall blown-out highlight image is generated), the side of the receiver may instruct the camera 10 to perform automatic image quality adjustment or to specify another predicted image quality parameter for rephotography.

In addition, upon image encoding by the camera 10, in a case where a photographed image is generated in which a large difference occurs both from a reference image and a latest image, compression or encoding may be performed on the overall actually photographed image, instead of on the difference image. In this case, a data amount of generated image data only needs to be equivalent to a data amount of a single piece of image such as JPEG (Joint Photographic Experts Group) or Intra (in frame) picture, even in the worst-case scenario. In addition, in a case where a large difference continues to occur in a reference image and a small difference continues in a latest image, the latest image may be adopted as a new reference image. In this occasion, adopting the latest image is effective, for example, in a case where a direction of the camera is changed.

### 2. Other Embodiments

The technology according to the present disclosure is not limited to the description of the embodiment described above, and may be modified in a wide variety of ways.

For example, the present technology may also have the following configurations.

According to the present technology of the following configurations, a reference image corresponding to a photographing condition at the time when photography has been performed is selected from among a plurality of reference images stored in a reference image storage unit, and a difference image between the selected reference image and an image captured by an imaging unit is generated, thus making it possible to reduce an image data amount and power consumption.

(1)

An imaging apparatus including:

an imaging unit that performs photography based on a predetermined photographing condition;

a reference image storage unit that stores a plurality of reference images corresponding to the photographing condition; and

an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit.

(2)

The imaging apparatus according to (1), further including:

an image quality parameter storage unit that stores a plurality of image quality parameters related to image quality adjustment corresponding to the photographing condition; and

an image processing unit that selects, in a case where the photography has been performed by the imaging unit, an image quality parameter corresponding to the photographing condition at the time when the photography has been performed, from among the plurality of image quality parameters stored in the image quality parameter storage unit, and performs image quality adjustment based on the selected image quality parameter on the image captured by the imaging unit.

(3)

The imaging apparatus according to (2), in which the encoding unit generates a difference image between the selected reference image and the captured image after having been subjected to the image quality adjustment by the image processing unit.

(4)

The imaging apparatus according to (2) or (3), further including an imaging control unit that selects an image quality parameter corresponding to the photographing condition from among the plurality of image quality parameters stored in the image quality parameter storage unit, and causes the imaging unit to perform photography based on the selected image quality parameter.

(5)

The imaging apparatus according to any one of (1) to (4), in which

the reference image storage unit stores the plurality of reference images and a latest image, which is newest in terms of time, captured by the imaging unit, and

the encoding unit generates a difference image between the latest image and the image captured by the imaging unit in a case where there is no reference image corresponding to the photographing condition at the time when the photography has been performed.

(6)

The imaging apparatus according to (4) or (5), in which

the image processing unit performs automatic image quality adjustment processing in a case where there is no image quality parameter corresponding to the photographing condition at the time when the photography has been performed, and

the imaging control unit causes the imaging unit to perform photography by means of automatic photography control in the case where there is no image quality parameter corresponding to the photographing condition at the time when the photography has been performed.

(7)

The imaging apparatus according to any one of (2) to (4), further including a communication unit that transmits, as image data, data on the difference image generated by the encoding unit to an external receiver.

(8)

The imaging apparatus according to (7), in which

the communication unit receives a reference image generated on a basis of the image data received by the external receiver, and

the reference image storage unit stores the reference image received by the communication unit from the external receiver.

(9)

The imaging apparatus according to (7) or (8), in which

the communication unit receives an image quality parameter generated on a basis of the image data received by the external receiver, and

the image quality parameter storage unit stores the image quality parameter received by the communication unit from the external receiver.

(10)

The imaging apparatus according to any one of (1) to (9), in which the photographing condition includes a condition concerning photographing time.

(11)

The imaging apparatus according to any one of (1) to (10), in which the imaging unit at least performs temporally regular photography on a basis of the photographing condition.

(12)

The imaging apparatus according to any one of (1) to (11), in which the imaging unit at least performs positionally regular fixed-point photography.

(13)

The imaging apparatus according to any one of (1) to (12), further including a sensor that measures external information during the photography by the imaging unit, in which

the photographing condition includes a condition based on information measured by the sensor.

(14)

The imaging apparatus according to any one of (1) to (13), in which the photographing condition includes a condition based on an external instruction of photography.

(15)

An image transmission/reception system including:

a transmitter that generates and transmits image data; and

a receiver that receives the image data transmitted from the transmitter,

the transmitter including
an imaging unit that performs photography based on a predetermined photographing condition,
a reference image storage unit that stores a plurality of reference images corresponding to the photographing condition,
an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit, and
a communication unit that transmits, as the image data, data on the difference image generated by the encoding unit.
   (16)

The image transmission/reception system according to (15), in which

the receiver includes

a reference image generation unit that generates the reference image on a basis of the image data from the transmitter, and

a transmission unit that transmits the reference image generated by the reference image generation unit to the transmitter.

(17)

The image transmission/reception system according to (16), in which

the transmitter further includes a sensor that measures external information during the photography by the imaging unit,

the communication unit of the transmitter transmits, together with the image data, the information measured by the sensor during the photography, and

the reference image generation unit generates the reference image on a basis of the image data and the measurement information from the transmitter.

(18)

The image transmission/reception system according to any one of (15) to (17), in which the transmitter further includes

an image quality parameter storage unit that stores a plurality of image quality parameters related to image quality adjustment corresponding to the photographing condition, and

an image processing unit that selects, in a case where the photography has been performed by the imaging unit, an image quality parameter corresponding to the photographing condition at the time when the photography has been performed, from among the plurality of image quality parameters stored in the image quality parameter storage unit, and performs image quality adjustment based on the selected image quality parameter on the image captured by the imaging unit.

(19)

The image transmission/reception system according to (18), in which

the receiver includes

an image quality parameter generation unit that generates the image quality parameter on a basis of the image data from the transmitter, and

the transmission unit that transmits the image quality parameter generated by the image quality parameter generation unit to the transmitter.

(20)

The image transmission/reception system according to (19), in which

the transmitter further includes the sensor that measures external information during the photography by the imaging unit,

the communication unit of the transmitter transmits, together with the image data, the information measured by the sensor during the photography, and

the image quality parameter generation unit generates the image quality parameter on a basis of the image data and the measurement information from the transmitter.

This application claims the benefit of Japanese Priority Patent Application JP2020-128663 filed with the Japan Patent Office on Jul. 29, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An imaging apparatus comprising:
an imaging unit that performs photography based on a predetermined photographing condition;
a reference image storage unit that stores a plurality of reference images corresponding to the photographing condition; and
an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit.

2. The imaging apparatus according to claim 1, further comprising:
an image quality parameter storage unit that stores a plurality of image quality parameters related to image quality adjustment corresponding to the photographing condition; and
an image processing unit that selects, in a case where the photography has been performed by the imaging unit, an image quality parameter corresponding to the photographing condition at the time when the photography has been performed, from among the plurality of image quality parameters stored in the image quality parameter storage unit, and performs image quality adjustment based on the selected image quality parameter on the image captured by the imaging unit.

3. The imaging apparatus according to claim 2, wherein the encoding unit generates a difference image between the selected reference image and the captured image after having been subjected to the image quality adjustment by the image processing unit.

4. The imaging apparatus according to claim 2, further comprising an imaging control unit that selects an image quality parameter corresponding to the photographing condition from among the plurality of image quality parameters stored in the image quality parameter storage unit, and causes the imaging unit to perform photography based on the selected image quality parameter.

5. The imaging apparatus according to claim 1, wherein
the reference image storage unit stores the plurality of reference images and a latest image, which is newest in terms of time, captured by the imaging unit, and
the encoding unit generates a difference image between the latest image and the image captured by the imaging unit in a case where there is no reference image corresponding to the photographing condition at the time when the photography has been performed.

6. The imaging apparatus according to claim 4, wherein
the image processing unit performs automatic image quality adjustment processing in a case where there is no image quality parameter corresponding to the photographing condition at the time when the photography has been performed, and
the imaging control unit causes the imaging unit to perform photography by means of automatic photography control in the case where there is no image quality parameter corresponding to the photographing condition at the time when the photography has been performed.

7. The imaging apparatus according to claim 2, further comprising a communication unit that transmits, as image data, data on the difference image generated by the encoding unit to an external receiver.

8. The imaging apparatus according to claim 7, wherein
the communication unit receives a reference image generated on a basis of the image data received by the external receiver, and
the reference image storage unit stores the reference image received by the communication unit from the external receiver.

9. The imaging apparatus according to claim 7, wherein
the communication unit receives an image quality parameter generated on a basis of the image data received by the external receiver, and
the image quality parameter storage unit stores the image quality parameter received by the communication unit from the external receiver.

10. The imaging apparatus according to claim 1, wherein the photographing condition includes a condition concerning photographing time.

11. The imaging apparatus according to claim 1, wherein the imaging unit at least performs temporally regular photography on a basis of the photographing condition.

12. The imaging apparatus according to claim 1, wherein the imaging unit at least performs positionally regular fixed-point photography.

13. The imaging apparatus according to claim 1, further comprising a sensor that measures external information during the photography by the imaging unit, wherein
the photographing condition includes a condition based on information measured by the sensor.

14. The imaging apparatus according to claim 1, wherein the photographing condition includes a condition based on an external instruction of photography.

15. An image transmission/reception system comprising:
a transmitter that generates and transmits image data; and
a receiver that receives the image data transmitted from the transmitter,
the transmitter including
an imaging unit that performs photography based on a predetermined photographing condition,
a reference image storage unit that stores a plurality of reference images corresponding to the photographing condition,
an encoding unit that selects, in a case where photography has been performed by the imaging unit, a reference image corresponding to the photographing condition at a time when the photography has been performed, from among the plurality of reference images stored in the reference image storage unit, and generates a difference image between the selected reference image and an image captured by the imaging unit, and
a communication unit that transmits, as the image data, data on the difference image generated by the encoding unit.

16. The image transmission/reception system according to claim 15, wherein
the receiver includes
a reference image generation unit that generates the reference image on a basis of the image data from the transmitter, and
a transmission unit that transmits the reference image generated by the reference image generation unit to the transmitter.

17. The image transmission/reception system according to claim 16, wherein
the transmitter further includes a sensor that measures external information during the photography by the imaging unit,
the communication unit of the transmitter transmits, together with the image data, the information measured by the sensor during the photography, and
the reference image generation unit generates the reference image on a basis of the image data and the measurement information from the transmitter.

18. The image transmission/reception system according to claim 15, wherein the transmitter further includes
an image quality parameter storage unit that stores a plurality of image quality parameters related to image quality adjustment corresponding to the photographing condition, and
an image processing unit that selects, in a case where the photography has been performed by the imaging unit, an image quality parameter corresponding to the photographing condition at the time when the photography has been performed, from among the plurality of image quality parameters stored in the image quality parameter storage unit, and performs image quality adjustment based on the selected image quality parameter on the image captured by the imaging unit.

19. The image transmission/reception system according to claim 18, wherein
the receiver includes
an image quality parameter generation unit that generates the image quality parameter on a basis of the image data from the transmitter, and
a transmission unit that transmits the image quality parameter generated by the image quality parameter generation unit to the transmitter.

20. The image transmission/reception system according to claim 19, wherein
the transmitter further includes a sensor that measures external information during the photography by the imaging unit,
the communication unit of the transmitter transmits, together with the image data, the information measured by the sensor during the photography, and
the image quality parameter generation unit generates the image quality parameter on a basis of the image data and the measurement information from the transmitter.
